(19) United States
(12) Patent Application Publication
(10) Pub. No.: US 2018/0008845 A1
(43) Pub. Date: Jan. 11, 2018

(54) Multifunctional Vehicle Tool

(71) Applicant: Ye Xu, Sugar Land, TX (US)

(72) Inventor: Ye Xu, Sugar Land, TX (US)

(21) Appl. No.: 15/656,287

(22) Filed: Jul. 21, 2017

Related U.S. Application Data
(63) Continuation-in-part of application No. 15/227,270, filed on Aug. 3, 2016, now Pat. No. 9,716,359.

(30) Foreign Application Priority Data
Jun. 28, 2016 (CN) 201620652867.X

(51) Int. Cl. A62B 3/00; B26B 11/00; B25F 1/00; H01R 31/06; B60R 22/32

(52) U.S. Cl. CPC A62B 3/005; H01R 31/06; B60R 22/32; B25F 1/006; B26B 11/008; B60R 2022/328

(57) ABSTRACT

Provided is a removable safety-locking device or safety clip for use with multifunctional tools in a car functioning as a cigarette lighter socket adapter, safety hammer and cutter. The safety-locking device has a flexible clip body that engages with the multifunctional tool to prevent accidental firing of the safety hammer or accidental injury or cutting by the cutter or blade. The flexible clip body has a substantially semicircular downwardly depending pair of arms and a knife-block formed at and extending from an apex of the pair of arms.

### CROSS-REFERENCE TO RELATED APPLICATION

This application is a continuation-in-part under 35 U.S.C. §120 of pending non-provisional application U.S. Ser. No. 15/227,270, filed Aug. 3, 2016, which claims benefit of priority under 35 U.S.C. §119(a) of Chinese Application No. 201620652867.X, filed Jun. 28, 2016, the entirety of which is hereby incorporated by reference.

### BACKGROUND OF THE INVENTION

### Field of the Invention

The present invention generally relates to the field of car accessories. More specifically, the present invention relates to a safety clip for use with a multifunctional device used as a cigarette lighter socket adapter, safety hammer and cutter in a car.

### Description of the Related Art

The cigarette lighter socket has become one of the most commonly used accessories in a vehicle with the development of the electronic devices. Generally, a plug is used to provide electricity from the cigarette lighter socket for outlet ports or any other connectors to various electronic devices.

A car safety hammer is usually used to break car windows, or cutting a safety belt to protect life or possessions in an emergency. Currently, a car safety hammer is most commonly seen in buses or other vehicles for public transportation. However, with increasing awareness of personal safety, more and more drivers are carrying a safety hammer in their personal vehicles.

Often, misplacing a regular safety hammer can easily distract the driver. Some drivers prefer to place the safety hammer in a glove box, console box or any other toolbox in the car. However, in an emergency such as a car crash, it could be difficult to access the safety hammer in time, defeating the purpose of having the safety hammer in the car. Furthermore, safety hammers in the market are generally not user friendly, and often provide very limited impact force to break car windows, resulting in uncertainty of the effectiveness of the safety hammer in a real emergency, especially for people with limited strength.

Therefore, there is a recognized need in the art for a user-friendly car safety hammer that can be placed in a highly accessibly place in a car, with improved impact force to break the windows of a vehicle, at the same time integrate the function of an adapter of a cigarette lighter socket. Particularly, the previous art is deficient in this aspect. The present invention fulfills this long-standing need and desire in the art.

### SUMMARY OF THE INVENTION

The present invention is directed to a removable safety-locking device or safety clip for use with a multifunctional tool functioning as a cigarette socket adapter, safety hammer and cutter or blade used in a car. The multifunctional tool comprises a flexible clip body configured to removably engage the multifunctional tool. The flexible clip body has a first proximal portion comprising a substantially semicircular downwardly depending pair of arms and a second distal portion comprising a knife-block formed at an apex of the first proximal portion and extending therefrom.

The present invention also is directed to a multifunctional tool functioning as a cigarette socket adapter, safety hammer and cutter used in a car. The multifunctional tool comprises the removable safety-locking device or safety clip as described herein, a body portion, an opening disposed in a longitudinal axial direction of the body portion; a hook-shaped structure formed on the body portion, a sliding holder, a floating spring, a striking member, a striking spring, an alignment member, a blade disposed on an inner surface of the hook-shaped structure, and means for adapting electricity from a cigarette lighter socket of a car. The sliding holder comprises an axial opening on a bottom surface thereof and is disposed in the opening of the body portion and is movable at the axial direction thereof, with a proximal end extending out of the body portion. The floating spring is disposed against a back surface of the sliding holder in the opening of the body portion. The striking member is disposed in the axial opening of the sliding holder and comprises a striking head, a rod-shaped body, a ring-shaped shoulder formed between the striking head and rod-shaped body, a flange formed at the end thereof distal from the striking head, and a transition gap disposed between a front side of the opening of the sliding holder and the shoulder of the striking member. The striking spring is disposed around the striking member in the axial opening between a stopper disposed at a back end of the axial opening against the striking spring and a back surface of the ring-shaped shoulder. The alignment member is disposed directly under the striking member through the opening of the sliding holder and comprises a guide ramp in contact with a back surface of the ring-shaped shoulder of the striking member and is configured to lift the striking member and align the striking member with a firing hole disposed on an proximal end of the body portion. The present invention is directed to a related multifunctional tool that further comprises a plurality of finger grips disposed on a surface of a distal end of the body portion.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1A is a perspective view of the multifunctional tool from the left and front side showing USB ports as the outlet ports for the adapter.

FIG. 1B is a perspective view of the multifunctional tool from the left and front side showing wired charger socket as the outlet connection for the adapter.

FIG. 2 is an exploded view of the multifunctional tool showing the left and right parts of the body portion and the inner structure thereof.

FIG. 3 is a perspective view of the multifunctional tool from the right and front side.

FIG. 4 is a sectional view of the multifunctional tool from the front view angle, showing the inner structure of the striking member and spring.

FIG. 5 is a sectional view of the multifunctional car safety hammer from the front view angle, showing the sliding holder pushing against the striking member thereof.

FIG. 6 is a sectional view of the multifunctional tool from the front view angle, showing the coaxial alignment member aligning the striking member to the firing hole.

FIG. 7 is a sectional view of the multifunctional tool from the front view angle, showing the aligned striking member is fired through the firing hole to complete the striking on an object.

FIG. 8 illustrates how the multifunctional tool is used to cut a seat belt.

FIG. 9A is a perspective view of the safety clip.

FIG. 9B is a perspective exploded view of the multifunctional tool from front and side showing the removable safety clip in an unlocked position.

FIG. 10A is a sectional view of the multifunctional tool without the removable safety clip, from the front view angle, showing the inner structure of the striking member and spring.

FIG. 10B is a sectional view of the multifunctional tool with the removable safety clip, from the front view angle, showing the inner structure of the striking member and spring.

FIG. 11A is an exploded view of the multifunctional tool showing the left and right parts of the body portion and the inner structure thereof.

FIG. 11B is a perspective view of the multifunctional tool with the proximal side of the body portion removed, from front and side showing that when the safety clip is in locked position on the body portion, it protrudes into the cylinder wall, preventing firing of the spring-loaded striking member.

FIG. 11C is a top view of the multifunctional tool with the proximal top portion of the body portion removed showing that when the safety clip is in locked position on the body portion, the safety stop protrudes into the cylinder wall, preventing firing of the spring-loaded striking member.

FIG. 12 is a perspective view of the assembled multifunctional tool from front and side showing the removable safety clip in a locked position.

FIG. 13 is a perspective view of the assembled multifunctional tool from back to front showing that when the safety clip is in locked position, the multifunctional tool can still be attached to the cigarette lighter for electrical functionality.

FIG. 14A is a perspective view of the assembled multifunctional tool from back to front showing USB ports as the outlet ports for the adapter.

FIG. 14B is a perspective view of the assembled multifunctional tool from back to front showing wired charger socket as the outlet connection for the adapter.

FIG. 15 illustrates how the multifunctional tool is used to cut a seat belt after the safety clip is removed.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the term “proximal” refers to the end of the multifunction tool that is nearer to the cigarette lighter socket”. Similarly, the term “distal” refers to the end of the device that is farther away from the cigarette lighter socket.

As used herein, the term “proximal” also refers to the end of the safety-locking device that is closer to the proximal end of the multifunction tool. Similarly, the term “distal” refers to the end of the safety-locking device that is closer to the distal end of the multifunction tool.

In one embodiment of the present invention, there is provided a safety-locking device for a multifunctional tool functioning as a cigarette socket adapter, safety hammer and cutter used in a car, comprising a flexible clip body configured to removably engage the multifunctional tool comprising a first proximal portion comprising a substantially semicircular downwardly depending pair of arms; and a second distal portion comprising a knife-block formed at an apex of the first proximal portion and extending therefrom.

In this embodiment, the pair of arms may comprise a pair of indents oppositely formed proximate to lower ends thereof. Also in this embodiment each of the indents may be curved inwardly. In addition the pair of arms may be configured to flex outwardly. Furthermore, the knife-block may be substantially J-shaped. Particularly, the substantially J-shaped knife-block may comprise a stem portion extending distally and tangentially from the apex of the first proximal portion; and a tail portion extending upwardly from a distal end of the stem portion.

In another embodiment of the present invention there is provided a multifunctional tool functioning as a cigarette socket adapter, safety hammer and cutter used in a car, comprising the safety-locking device as described supra; a body portion comprising a first cutout formed on an outer surface of the body portion that is configured to removably engage the first proximal portion of the safety-locking device; a second cutout formed on the outer surface of the body portion that is configured to removably engage the second distal portion of the safety-locking device; a proximal end that fits in a cigarette lighter socket of a car; a positive contact disposed at the proximal end of the body portion; one or more negative retainers disposed on the side surface of the body portion; an opening disposed in a longitudinal axial direction of the body portion; a hook-shaped structure formed on the body portion; a sliding holder comprising an axial opening on a bottom surface thereof, disposed in said opening of the body portion movable at the axial direction thereof, with a proximal end extending out of the body portion; a floating spring disposed against a back surface of the sliding holder in the opening of the body portion; a striking member disposed in the axial opening of the sliding holder, comprising a striking head; a rod-shaped body; a ring-shaped shoulder formed between said striking head and rod-shaped body; a flange formed at the end thereof distal from the striking head; and a transition gap disposed between a front side of the opening of the sliding holder and the shoulder of the striking member; a striking spring disposed around said striking member in the axial opening between a stopper disposed at a back end of the axial opening against said striking spring and a back surface of the ring-shaped shoulder; an alignment member, disposed directly under the striking member through the opening of the sliding holder, comprising a guide ramp in contact with a back surface of the ring-shaped shoulder of the striking member configured to lift said striking member and align said striking member with a firing hole disposed on an proximal end of the body portion; a blade disposed on a inner surface of the hook-shaped structure; and means for adapting electricity from a cigarette lighter socket of a car.

Further to this embodiment the multifunctional tool may comprise a plurality of finger grips disposed on a surface of a distal end of the body portion.

In both embodiments, when engaged with the cutout, the downwardly depending pair of arms are disposed in a blocking relationship at the proximal ends thereof with a distal end of the sliding holder. Also in both embodiments the pair of arms comprise at each distal end thereof an inwardly curved indent that abuts the floating spring at a lateral position along the longitudinal axis of the body portion. In addition the opening of the body portion may be substantially cylindrical.

In both embodiments the sliding holder may be substantially cylindrical with a diameter substantially the same as a diameter of the opening disposed in an axial direction of the body portion and may comprise an opening at a bottom surface thereof, disposed around the alignment member. Also the firing hole and the axial opening of the sliding holder may be substantially concentric. In addition, the striking head may be substantially cone-shaped.

In both embodiments the ring-shaped shoulder may have a diameter that is substantially the same as a diameter of the axial opening of the sliding holder. Particularly, the shoulder may comprise a front surface disposed against a side of the opening at the bottom of the sliding holder when the striking spring is not released. Also the stopper may tilt forward to push the striking spring and striking head downwards.

In yet another embodiment of the present invention, there is provided a multifunctional device for a user of a car, comprising a body portion comprising a proximal end that fits in a cigarette lighter socket of a car; a positive contact disposed at the proximal end of the body portion; one or more negative retainers disposed on the side surface of the body portion; an opening disposed in an axial direction of the body portion; a hook-shaped structure formed on the body portion; a striking mechanism disposed in the body portion; a blade disposed on a inner surface of the hook-shaped structure; and means for adapting electricity from a cigarette lighter socket of a car.

In this embodiment, the opening of the body portion may be substantially cylindrical. Also in this embodiment the striking mechanism may comprise a sliding holder comprising an axial opening, disposed in the opening of the body portion movable at the axial direction thereof, with a proximal end extending out of the body portion; a floating spring disposed against a back surface of the sliding holder in the opening of the body portion; a striking member disposed in the axial opening of the sliding holder; a striking spring disposed around the striking member in the axial opening; a stopper disposed at a back end of the axial opening against the striking spring; an alignment member formed on a inner surface of the body portion comprising a guide ramp configured to lift the striking member and align the striking member with a firing hole disposed on an proximal end of the body portion.

In an aspect thereof, the sliding holder may comprise an opening at a bottom surface thereof disposed around the alignment member. In another aspect the sliding holder may be substantially cylindrical with a diameter substantially the same as a diameter of the opening disposed in an axial direction of the body portion. In yet another aspect, the firing hole and the axial opening of the sliding holder may be substantially concentric.

In yet another aspect, the striking member may comprise a striking head; a rod-shaped body; a ring-shaped shoulder formed between the striking head and rod-shaped body with a back surface in contact with the guide ramp of the alignment member; and a flange formed at the end thereof distal from the striking head. In this particular aspect, the striking head may be substantially cone-shaped. Also the ring-shaped shoulder may have a diameter that is substantially the same as a diameter of the axial opening of the sliding holder. In addition, the shoulder comprises a front surface disposed against a side of the opening at the bottom of the sliding holder when the striking spring is not released. Furthermore the striking spring may be disposed between a back surface of the ring-shaped shoulder and the stopper. Further still the stopper may tilt forward to push the striking spring and striking head downwards.

In yet another embodiment of the present invention, there is provided a multifunctional tool functioning as a cigarette lighter socket adapter, safety hammer and cutter used in a car, comprising the multifunctional tool comprising a body portion, an opening disposed in a longitudinal axial direction of the body portion; a hook-shaped structure formed on the body portion, a sliding holder, a floating spring, a striking member, a striking spring, an alignment member, a blade disposed on an inner surface of the hook-shaped structure, and means for adapting electricity from a cigarette lighter socket of a car, as described supra. In this embodiment and aspects thereof, the structural features and characteristics of the opening, the sliding holder, the firing hole and the axial opening of the sliding holder, the striking member, the striking head, the ring-shaped shoulder, the striking spring, and the stopper are as described supra.

Provided herein is a removable safety-locking device or safety clip for a multifunctional tool that functions as both a cigarette lighter socket adapter and as a safety tool incorporating a car safety hammer and a seat belt cutter or blade. Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

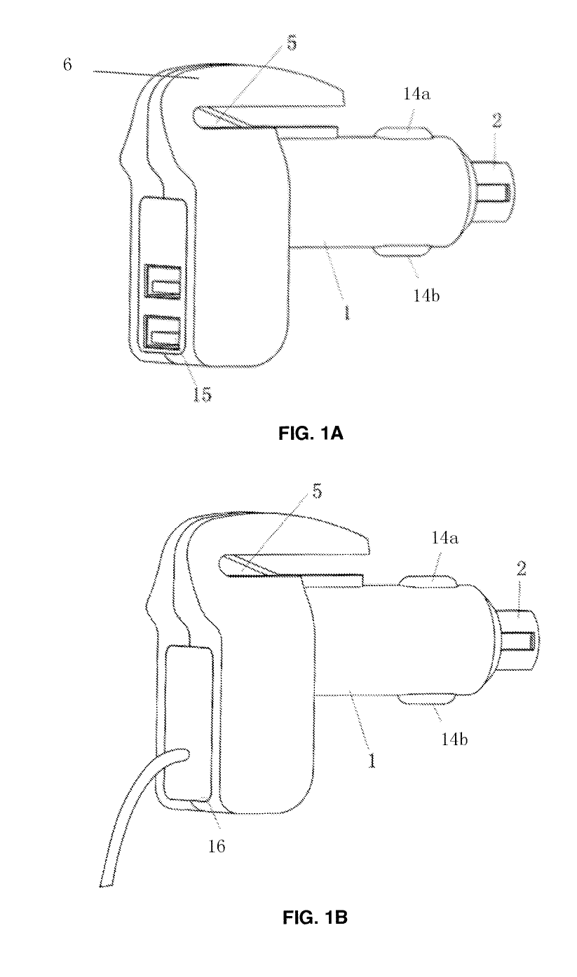

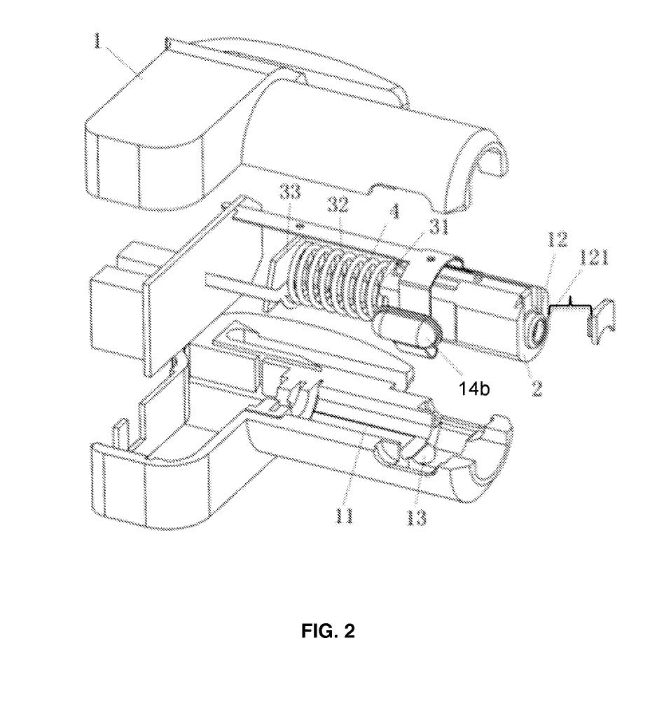

FIG. 1A depicts the device generally comprising the adapter and the safety tool. The device comprises a body portion 1 at a proximal end of the device and an external hook shaped structure 6 formed on top of the body portion at the distal end of the device. The body portion substantially contains a striking assembly with a safety hammer (see FIG. 2). The hook shaped structure comprises a blade 5 disposed on the inner surface of the hook-shaped structure and a plurality of output interfaces 15, such as USB ports disposed on the distal end thereof. The output interface may be any other types of connectors or ports for electronic connections. A sliding holder 2 is disposed in the body portion. The negative retainers 14a, 14b configured for conducting current from the cigarette lighter socket are disposed on the proximal end of the body portion. With continued reference to FIG. 1A, FIG. 1B shows a wired charger socket 16 as an alternative to a USB port.

With continued reference to FIG. 1A, FIG. 2 is an exploded view of the device depicting the safety hammer. FIG. 2 shows a positive contact 12 disposed around a firing hole 121 through which the car safety hammer emerges. A striking assembly comprises a striking member 31, a striking spring 32 disposed around the striking member, a sliding holder 2 are disposed in a recess or socket 11 of the body portion, a floating spring 4 disposed against a back surface of the sliding holder, a stopper 33 disposed at the back end of a socket or recess 11 of the body portion, and an alignment member 13 formed on a inner surface of the body portion.

The proximal end of the body portion 1 forms the socket or recess 11 into which the sliding holder fits and slides in the axial direction thereof. The sliding holder is substantially in a shape of a hollow cylinder. The striking member 31 is movably disposed in the sliding holder. The opening 21 of the sliding holder and the firing hole 121 are substantially co-axial. The proximal end of the sliding holder extends through the proximal end of the body portion 1. When the device is used as a safety hammer, the sliding holder 2 triggers the striking assembly to shoot the striking member 31 thereof out of the body portion through the firing hole 121, resulting in a high impact striking movement, which enables the user to escape from the windows of the vehicle in an emergency.

With continued reference to FIGS. 1A and 2, FIG. 3 is a perspective view of the device that better illustrates the positive contact 12 disposed at the proximal end of the sliding holder 2 around the firing hole 121. The positive contact 12 of the device conducts electricity through the floating spring 4 (see FIG. 2) in the body portion 1. Preferably, the firing hole is disposed substantially in the center of the positive contact. The body portion 1 of the device is a composite structure of two-halves for easy assembly as shown in FIG. 2.

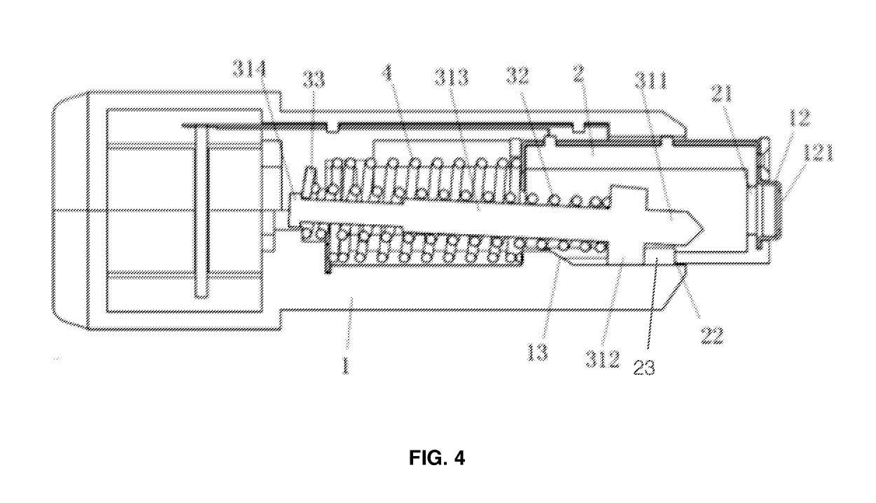

With continued reference to FIG. 2, FIG. 4 shows that the striking member comprises a substantially rod-shaped body 313, a shoulder 312 disposed around the proximal end of the rod-shaped body and a striking head 311 disposed on and proximal to the shoulder. A striking spring 32 is disposed around the striking member with a proximal end abutting the shoulder and a distal end abutting a proximal surface of stopper 33 that is disposed at the distal end of the socket of the body portion 1. A flange 314 with a diameter greater than that of the striking spring is formed at the distal end of the rod-shaped body of the striking member and is disposed through the stopper where a proximal surface of the flange abuts a distal surface of the stopper, such that the flange can limit the range of motion for the striking member. When the striking member is in motion, the shoulder 312 moves forward against the front surface of the proximal end of the body portion further control the range of the motion of the striking member. When the safety hammer is not in striking mode, the striking head 311 stays below the firing hole, and the sliding holder is pushed back, pressing against the striking spring 32. An alignment member 13 comprising a guide ramp is disposed directly under the striking member through an opening 22 on the bottom surface of the sliding holder. A transition gap 23 is disposed between the front side of the opening 22 and the shoulder 312 of the striking member to enable the function of the device as an adapter for the cigarette lighter socket and to avoid the misfiring of the safety hammer. The striking spring 32 is disposed around the striking spring. The stopper 33 tilts forwardly in an angle such that the striking member is pushed downwardly, keeping the striking head 311 off from the firing hole when it is not triggered.

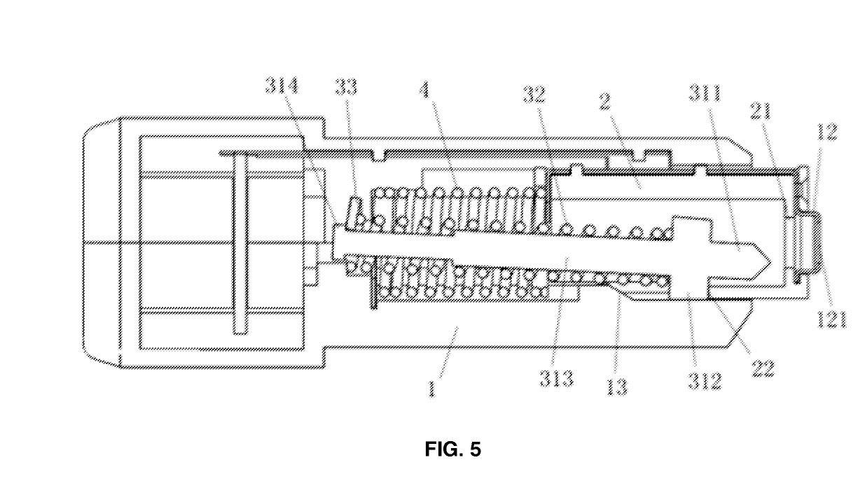

FIG. 5 depicts the front side of the opening 22 at the bottom of the sliding holder in contact with the shoulder 312 of the striking member. The alignment member 13 is configured to lift the shoulder 312 of the striking member. The diameter of the shoulder 312 is substantially the same as the inner diameter of the sliding holder 2, ensuring that the striking member is consistently and accurately aligned with the firing hole when the alignment member is triggered.

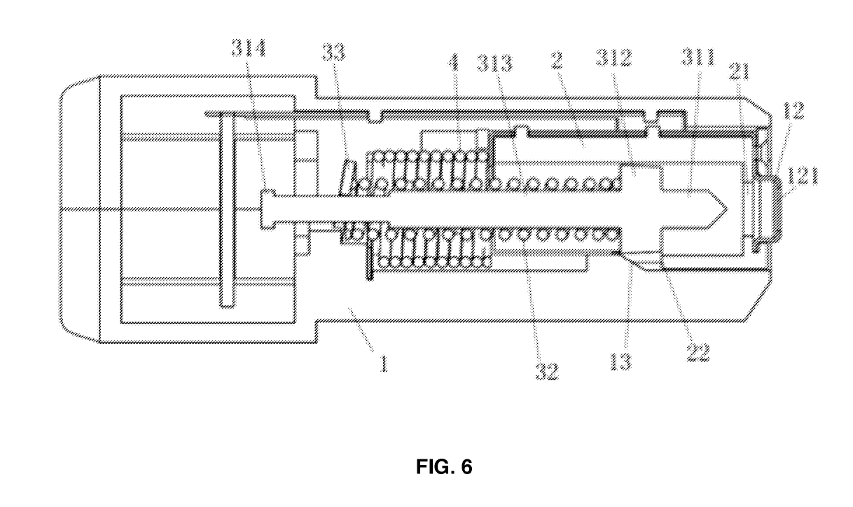

FIG. 6 depicts the configuration of the device when the proximal end of the sliding holder 2 is pressed against a target, resulting in the holder 2 retracting toward the inside of the body 1. Consequently, the shoulder 312 of the striking member that is trapped in the opening 22 at the bottom of the holder is pushed backwards and pressing against the striking spring 32. At the same time the alignment member guide the shoulder 312 upwards to align the striking head with the firing hole while the shoulder 312 is lifted up off the opening 22, resulting in the release of the striking spring 32, which propels the striking head to shoot out of the firing hole.

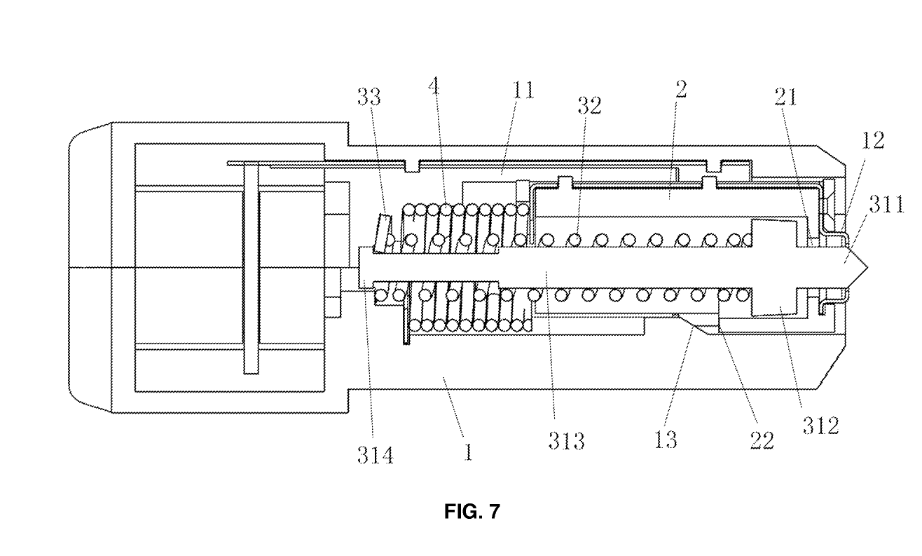

With continued reference to FIG. 6, FIG. 7 shows the striking member is out of the firing hole. Preferably, the striking head 311 is substantially cone-shaped, maximizing the ability to shatter the car window.

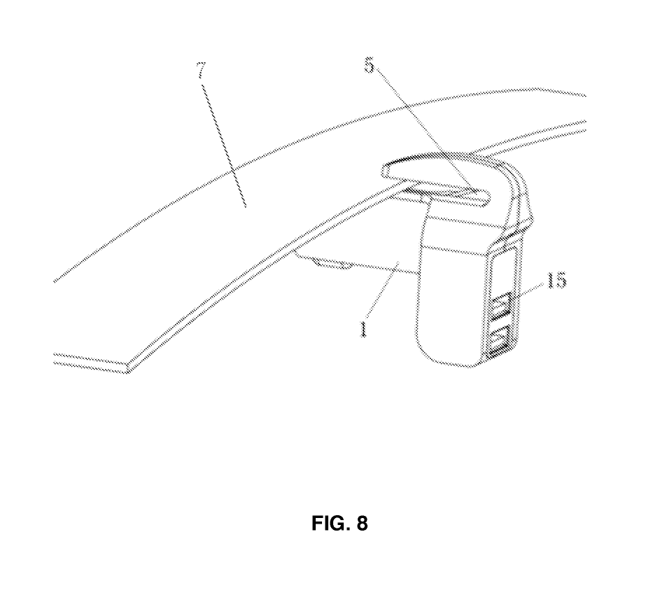

FIG. 8 illustrates the use of the blade 5 in the device. The external hook-like structure 6 is shaped to receive a seat belt 7 or other straps or objects therein to contact the blade disposed in the inner surface of the hook. The position of the blade enables the seat belt or other objects or straps to be cut to release a user or other individual trapped in a car in an emergency.

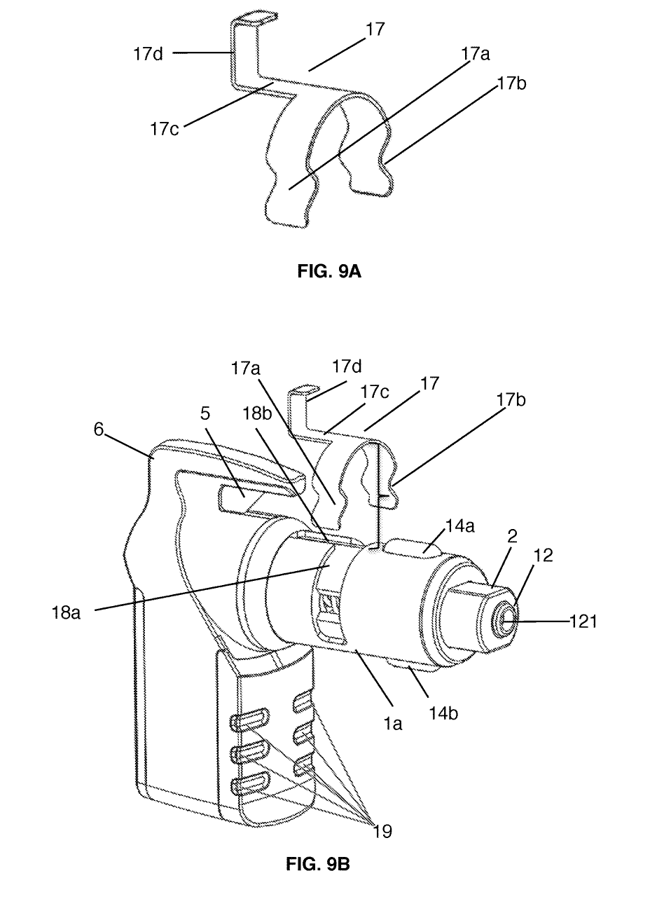

FIG. 9A depicts the safety clip 17. The safety clip comprises a first proximal portion comprising a substantially semicircular downwardly depending pair of arms and a second distal portion comprising a knife-block formed at an apex of the first portion and extending therefrom. The pair of arms further comprises a pair of inwardly curved indents 17a,b oppositely formed, proximate to the lower ends of the first portion. The pair of arms is configured to flex outwardly. The knife-block further comprises a stem portion 17c extending distally and tangentialy from the apex of first proximal portion and a tail portion 17d extending upwardly from a distal end of the stem portion.

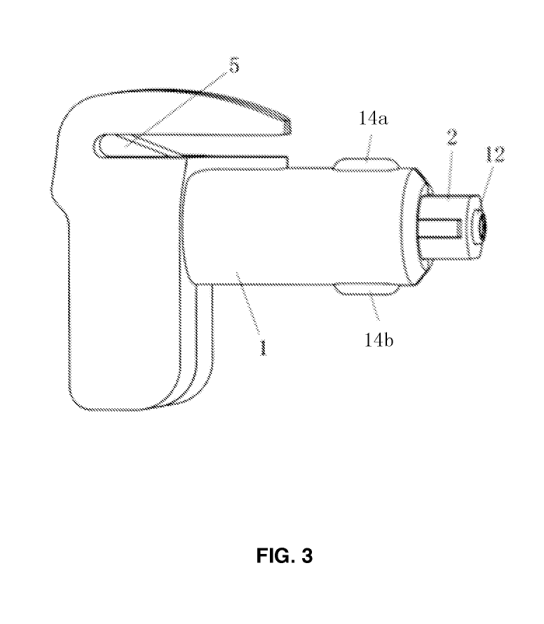

With continued reference to FIG. 3, FIG. 9B depicts an exploded view of the multifunctional tool generally comprising the safety clip, adapter and the safety tool. The multifunctional tool comprises a removable safety clip 17 having a substantially J-shaped knife-block 17c,d, a body portion 1a at a proximal end of the device and an external hook shaped structure 6 formed on top of the body portion at the distal end of the device. The body portion comprises a first cutout 18a formed on the outer surface of the body portion that is substantially semicircular and disposed at a medial position, distal to the negative retainers 14a, 14b. The body portion further comprises a second cutout 18b formed on the outer surface of the body portion that extends tangential from an apex of the first cutout to the distal end of the body portion. Cutouts 18a,b are configured to removably receive the safety-locking device.

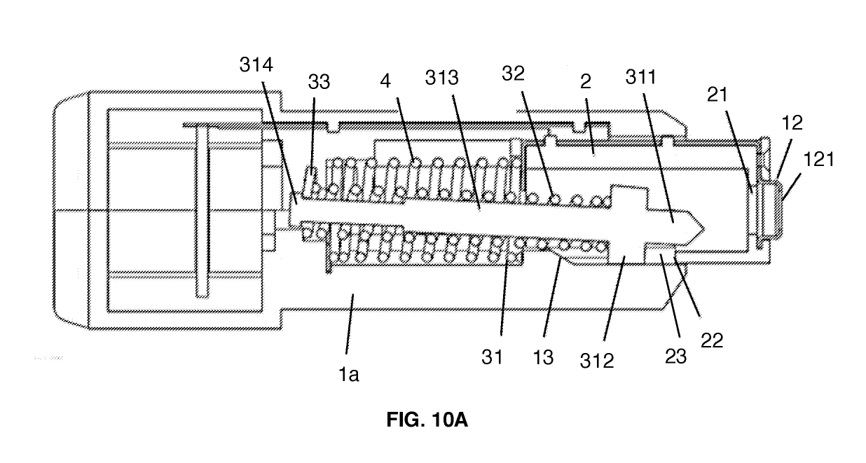

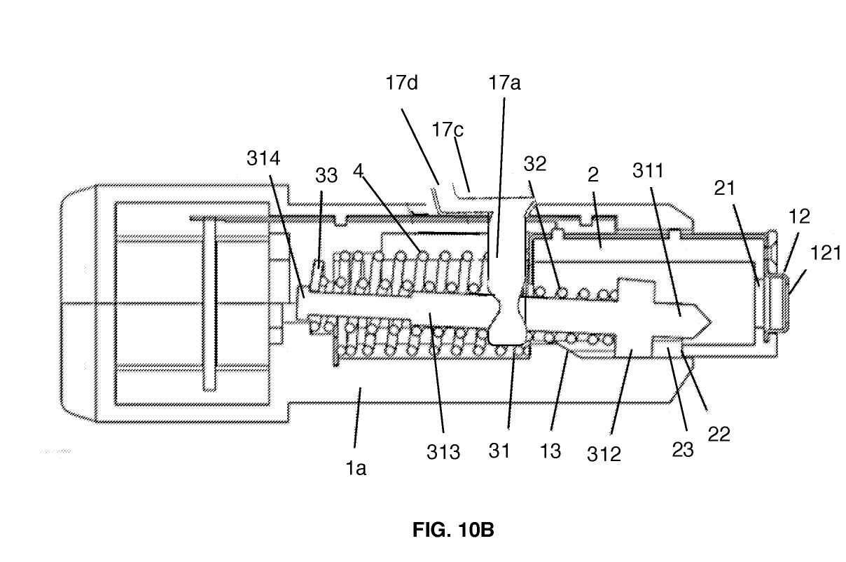

With continued reference to FIGS. 4-7, FIGS. 10A and 10B depict a sectional view of the body portion to expose the striking assembly. FIG. 10A depicts a sectional view of the striking assembly with the safety clip removed, so the multifunction tool is in an unlocked, “ready for use” position. FIG. 10B depicts a sectional view of the striking assembly with the safety clip engaged inside the cutout in the outer surface of the body portion and protruding into the striking assembly. Only the stem portion 17c, part of the upwardly extending tail portion 17d and one arm with indent 17a are shown. FIG. 10B shows that when the safety clip is engaged inside the cutouts in the body portion in a locked configuration, the first proximal portion of the safety clip abuts the back surface of sliding holder 2, the indents 17a,b (see FIGS. 9A-9B for 17b) abut the floating spring and the second distal portion of the safety clip abuts hook-like structure 6 that houses blade 5. Thus, in the locked configuration shown, sliding holder 2 is prevented from retracting towards the inside of the body portion and compressing the floating spring 4. Consequently, the shoulder 312 of the striking member that is trapped in the opening 22 at the bottom of the holder cannot be pushed backwards and pressed against the striking spring 32. Subsequently, the shoulder 312 cannot be guided upwards by alignment member 13 and therefore, the striking head cannot be aligned with the firing hole and propelled by striking spring 32 to shoot out of the firing hole and glass breakage is prevented.

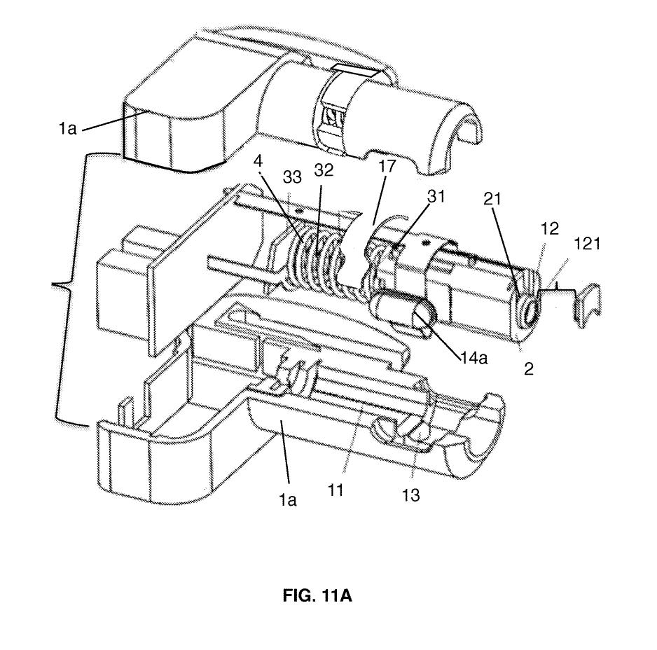

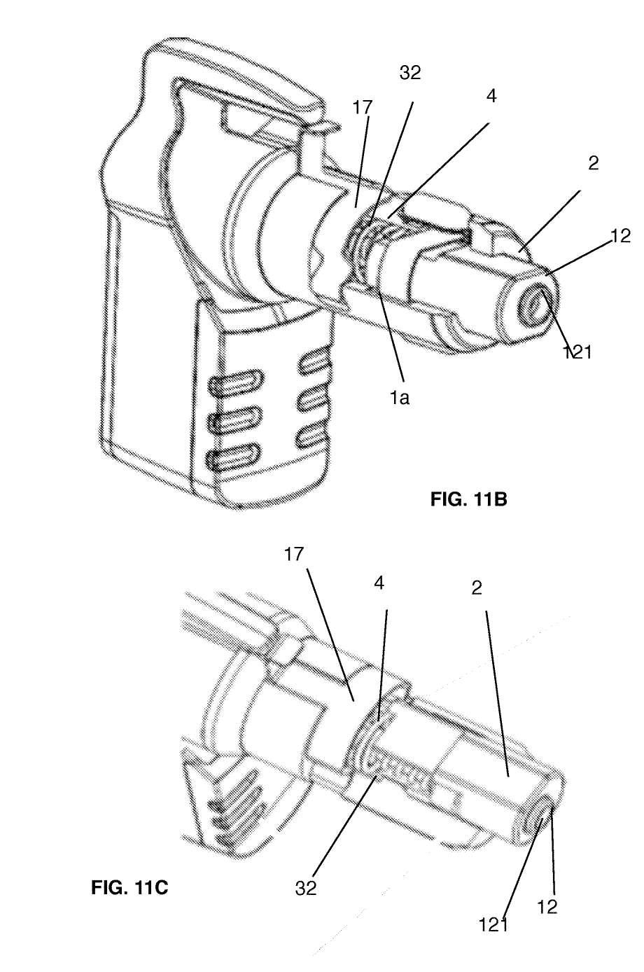

With continued reference to FIGS. 2 and 9B, FIG. 11A is an exploded side view of the system with side view of safety clip 17 in assembled (locked) position, FIG. 11B is a perspective front and side view of the device with left side portion of the body wall removed and FIG. 11C is a top sectional view of the device with the top section of the body portion removed. FIGS. 11A-11C show that the safety clip 17 is configured to engage and fit into the cutout 18a,b in the wall of the body portion 1a when the device is not in use. In this arrangement, the safety clip 17 protrudes into the cylinder wall and abuts the back surface of sliding holder 2 to prevent firing of the striking member 31.

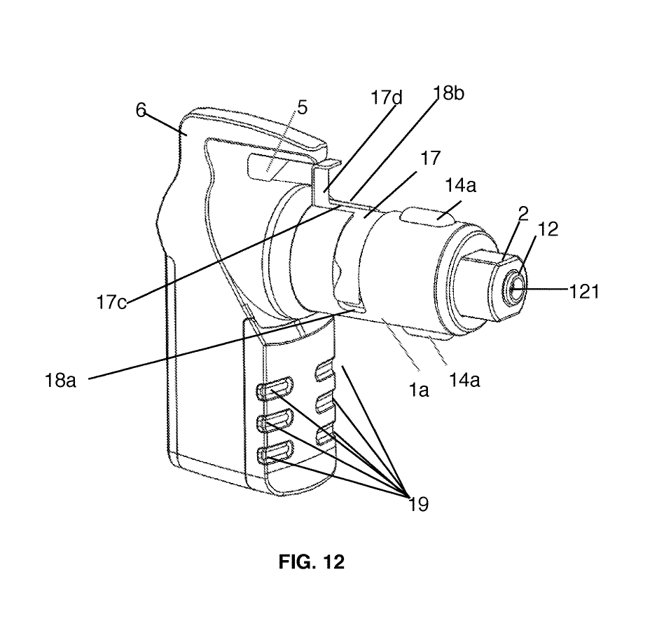

With continued reference to FIG. 3, FIG. 12 is a perspective front and side view of the assembled, locked system wherein safety clip 17 engages cutouts 18a,b on the wall of the body portion, thereby preventing activation of the striking member and the flange 17c,d portion of the safety clip prevents use of the belt cutter blade 5. Also provided on the lower end of the system is a plurality of finger grips, as represented by 19.

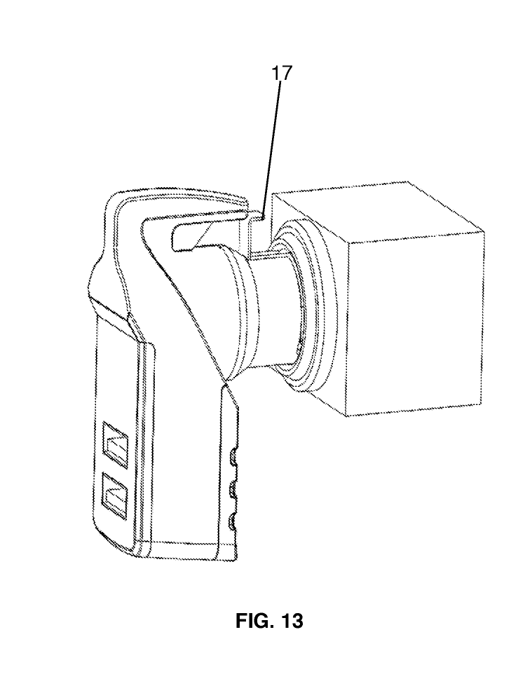

With continued reference to FIGS. 11A-11C, FIG. 13 shows that when the safety clip is in locked position, the device can still be attached to the cigarette lighter socket of a car for electrical outlet functionality.

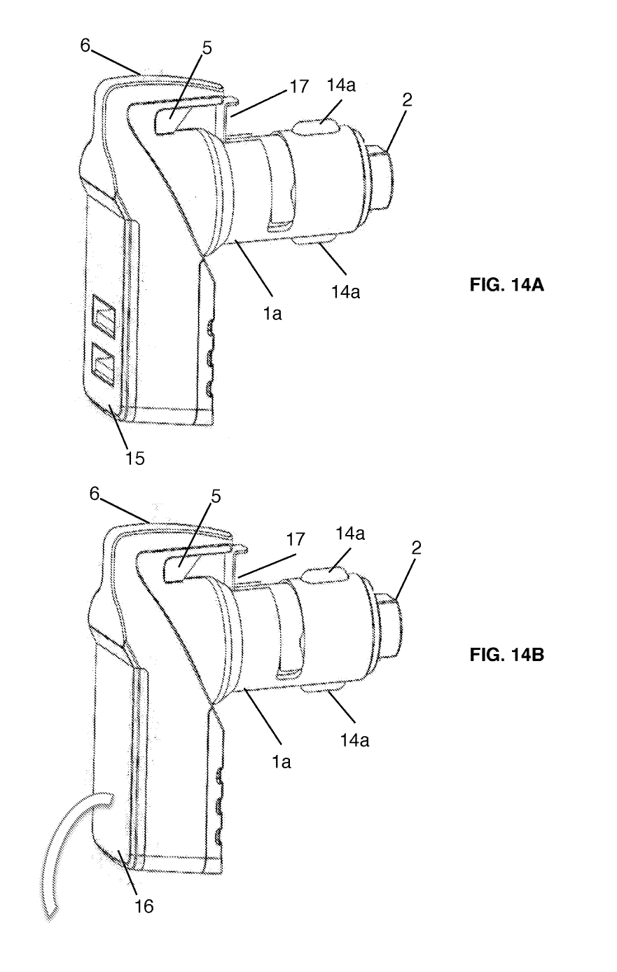

With continued reference to FIGS. 1A, FIGS. 14A-14B show that the hook shaped structure 6 comprises a blade 5 disposed on the inner surface of the hook-shaped structure; a sliding holder 2 is disposed in the body portion and negative retainers 14a,b disposed on the proximal end of the body portion configured for conducting current from the cigarette lighter socket. FIG. 14A shows a plurality of output interfaces such as USB ports 15 disposed on the distal end thereof. The output interface may be any other types of connectors or ports for electronic connections. With continued reference to FIG. 1B, FIG. 14B shows one such wired charger socket 16 as an alternative to the USB port.

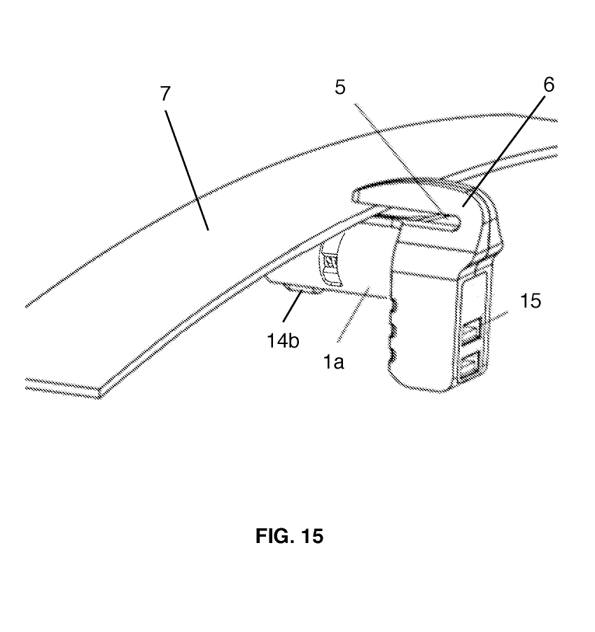

With continued reference to FIGS. 8 and 12, FIG. 15 shows that detachment of the removable safety clip allows external hook-like structure 6 to receive the seat belt 7 or other straps or objects therein for cutting by blade 5 thereby releasing a user or other individual trapped in a car in an emergency. The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. A safety-locking device for a multifunctional tool functioning as a cigarette socket adapter, safety hammer and cutter used in a car, comprising:
a flexible clip body configured to removably engage the multifunctional tool comprising:
a first proximal portion comprising a substantially semicircular downwardly depending pair of arms; and
a second distal portion comprising a knife-block formed at an apex of the first proximal portion and extending therefrom.

2. The safety-locking device of claim 1, wherein the pair of arms comprise a pair of indents oppositely formed proximate to lower ends thereof.

3. The safety-locking device of claim 1, wherein each of the indents is curved inwardly.

4. The safety-locking device of claim 1, wherein the pair of arms is configured to flex outwardly.

5. The safety-locking device of claim 1, wherein the knife-block is substantially J-shaped.

6. The safety-locking device of claim 5, wherein the substantially J-shaped knife-block comprises:
a stem portion extending distally and tangentially from the apex of the first proximal portion; and
a tail portion extending upwardly from a distal end of the stem portion.

7. A multifunctional tool functioning as a cigarette socket adapter, safety hammer and cutter used in a car, comprising:
the safety-locking device of claim 1;
a body portion comprising:
a first cutout formed on an outer surface of the body portion that is configured to removably engage the first proximal portion of the safety-locking device;
a second cutout formed on the outer surface of the body portion that is configured to removably engage the second distal portion of the safety-locking device;
a proximal end that fits in a cigarette lighter socket of a car;
a positive contact disposed at the proximal end of the body portion;
one or more negative retainers disposed on the side surface of the body portion;
an opening disposed in a longitudinal axial direction of the body portion;
a hook-shaped structure formed on the body portion;
a sliding holder comprising an axial opening on a bottom surface thereof, disposed in said opening of the body portion movable at the axial direction thereof, with a proximal end extending out of the body portion;
a floating spring disposed against a back surface of the sliding holder in the opening of the body portion;
a striking member disposed in the axial opening of the sliding holder, comprising:
a striking head;
a rod-shaped body;
a ring-shaped shoulder formed between said striking head and rod-shaped body;
a flange formed at the end thereof distal from the striking head; and
a transition gap disposed between a front side of the opening of the sliding holder and the shoulder of the striking member;
a striking spring disposed around said striking member in the axial opening between a stopper disposed at a back end of the axial opening against said striking spring and a back surface of the ring-shaped shoulder;
an alignment member, disposed directly under the striking member through the opening of the sliding holder, comprising a guide ramp in contact with a back surface of the ring-shaped shoulder of the striking member configured to lift said striking member and align said striking member with a firing hole disposed on an proximal end of the body portion;
a blade disposed on a inner surface of the hook-shaped structure; and
means for adapting electricity from a cigarette lighter socket of the car.

8. The multifunctional tool of claim 7, further comprising a plurality of finger grips disposed on a surface of a distal end of the body portion.

9. The multifunctional tool of claim 7, wherein, when engaged with the cutout, the downwardly depending pair of arms are disposed in a blocking relationship at the proximal ends thereof with a distal end of the sliding holder.

10. The multifunctional tool of claim 7, wherein the pair of arms comprise at each distal end thereof an inwardly curved indent that abuts the floating spring at a lateral position along the longitudinal axis of the body portion.

11. The multifunctional tool of claim 7, wherein said opening of the body portion is substantially cylindrical.

12. The multifunctional tool of claim 7, wherein said sliding holder is substantially cylindrical with a diameter substantially the same as a diameter of the opening disposed in an axial direction of the body portion and comprises an opening at a bottom surface thereof, disposed around said alignment member.

13. The multifunctional tool of claim 7, said firing hole and said axial opening of the sliding holder are substantially concentric.

14. The multifunctional tool of claim 7, wherein said striking head is substantially cone-shaped.

15. The multifunctional tool of claim 7, wherein said ring-shaped shoulder has a diameter that is substantially the same as a diameter of the axial opening of the sliding holder.

16. The multifunction tool of claim 15, wherein the shoulder comprises a front surface disposed against a side of said opening at the bottom of the sliding holder when the striking spring is not released.

17. The multifunctional device of claim 7, wherein said stopper tilts forward to push the striking spring and striking head downwards.
